(19) United States
(12) Patent Application Publication
(10) Pub. No.: US 2025/0356852 A1
(43) Pub. Date: Nov. 20, 2025

(54) IN-VEHICLE GENERATION OF ROUTINES USING VOICE COMMANDS

(71) Applicant: HARMAN INTERNATIONAL INDUSTRIES, INCORPORATED, Stamford, CT (US)

(72) Inventors: Ruchika KUMAR, Bangalore (IN); Harbinder SINGH, Bangalore (IN); Ravi Shanker GUPTA, Bangalore (IN); Ankur JHA, Bangalore (IN)

(21) Appl. No.: 18/864,789

(22) PCT Filed: May 10, 2023
(86) PCT No.: PCT/US2023/021758

§ 371 Date: Nov. 11, 2024

(30) Foreign Application Priority Data
May 11, 2022 (IN) 202241027139

(51) Int. Cl. G10L 15/22; B60K 35/10; B60K 35/22; G10L 15/04; G10L 15/18

(52) U.S. Cl. CPC G10L 15/22; B60K 35/10; B60K 35/22; G10L 15/04; G10L 15/1815; G10L 15/1822; B60K 2360/148; B60K 2360/1523; B60K 2360/164; B60K 2360/166; G10L 2015/223; G10L 2015/228

(57) ABSTRACT

Various embodiments disclose a computer-implemented method comprising receiving auditory speech signals generated by a user, mapping a first speech portion in the auditory speech signals to a first condition, where the first condition corresponds to a value associated with operation of a first component of a vehicle, mapping a second speech portion in the auditory speech signals to a first action, where the first action corresponds to a first action performed by a second component of the vehicle, generating a routine that includes the first condition and the first action, comparing the routine to a set of stored rules, upon determining that the routine does not overlap with at least one stored rule, storing the routine as a first stored rule, subsequent to storing the first stored rule, determining that the first condition has been satisfied, and causing the second component of the vehicle to perform the first action.

### CROSS-REFERENCE TO RELATED APPLICATIONS

This application claims the priority of co-pending Indian patent application titled “IN-VEHICLE GENERATION OF ROUTINES USING VOICE COMMANDS”,” filed on May 11, 2022, and having application No. 202241027139. The subject matter of this related application is hereby incorporated herein by reference.

### BACKGROUND

### Field of the Various Embodiments

Embodiments disclosed herein relate to digital assistants and, in particular, to in-vehicle generation of routines using voice commands.

### Description of the Related Art

Various digital systems include digital assistants that assist users to perform tasks. For example, various vehicles include a digital assistant that communicates with subsystems such as an advanced driver assistance system (ADAS), an infotainment system, a navigation system, and so forth, to assist users of a vehicle. In some vehicles, various subsystems can perform routines, where the vehicle performs specific actions based on specific conditions associated with the vehicle. For example, the ADAS can cause the vehicle to turn on the headlights of a vehicle based on specific conditions, such as determining the time of day or upon receiving sensor data indicating low visibility. Typically, users of the vehicle can interact with the digital assistant to add other routines for the vehicle to perform. For example, the user can program the infotainment unit to play a specific audio source upon vehicle startup.

One drawback of conventional digital assistants in vehicles is that such systems are not configured to enable or encourage non-expert users to generate routines for the vehicle to perform. In particular, such systems have complex interfaces that are navigable only by experienced users who have a deep understanding of the conditions that a vehicle can detect and the actions the vehicle can perform. As a result of this architecture, current digital systems cannot be extended for programming by users that do not already have deep knowledge of the interface to program new vehicle routines. Because of this limitation, many digital assistants are not effectively utilized by vehicle users and cause the users to manually perform certain tasks. In addition, because the user does not program the digital assistant to perform certain routines in response to detected conditions, the user may experience negative interactions with the vehicle. For example, in the absence of a programmed routine, the user may have to respond to detected precipitation by manually turning on one or more sets of windshield wipers and closing all vehicle windows.

As the foregoing illustrates, there is a need in the art for more effective techniques for programming personalized routines associated with the operation of a vehicle.

### SUMMARY

Various embodiments disclose a computer-implemented method comprising receiving a set of auditory speech signals generated by a user, mapping a first speech portion in the set of auditory speech signals to a first condition, where the first condition corresponds to at least a first value associated with an operation of a first component of a vehicle, mapping a second speech portion in the set of auditory speech signals to a first action, where the first action corresponds to at least a first action performed by a second component of the vehicle, generating a routine that includes the first condition and the first action, comparing the routine to a set of stored rules, where each stored rule in the set of stored rules includes at least one condition and at least one action, upon determining that the routine does not overlap with at least one stored rule in the set of stored rules, storing the routine as a first stored rule, subsequent to storing the first stored rule, determining that the first condition has been satisfied, and causing the second component of the vehicle to perform the first action.

At least one technical advantage of the disclosed techniques relative to the prior art is that, with the disclosed techniques, users that are not proficient in programming customized vehicle routines can effectively generate and approve custom vehicle routines that respond to various detected conditions, greatly improving the in-vehicle experience for users of the vehicle. In particular, by processing the speech of a user to generate a valid routine to store and monitor, the routines management application relieves users of a vehicle of physical and mental strain to perform a variety of manual tasks associated with the operation of the vehicle. Further, by interpreting the sentiment of a user when dictating a personalized routine, the personalized routines management system provides wider ranges of available conditions to monitor and actions to perform than menu-based user interfaces. These technical advantages provide one or more technological advancements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a personalized routines management system according to one or more embodiments.

FIG. 2 illustrates an example vehicle system that includes a routines management application and a hybrid interface engine of FIG. 1, according to various embodiments.

FIG. 3 illustrates an example personalized routines table included in the personalized routines management system of FIG. 1, according to various embodiments.

FIG. 4 illustrates a technique of the personalized routines management system of FIG. 1 creating a stored rule and responding to a triggering of the stored rule, according to various embodiments.

FIG. 5 illustrates an interaction diagram between various components of the personalized routines management system of FIG. 1, according to various embodiments.

FIG. 6 sets forth a flow chart of method steps for generating a rule corresponding to a personalized routine specified by a user, according to various embodiments.

FIG. 7 sets for a flow chart of method steps for responding to detection of one or more satisfied conditions of a rule by performing an action specified by the rule, according to various embodiments.

### DETAILED DESCRIPTION

In the following description, numerous specific details are set forth to provide a more thorough understanding of the various embodiments. However, it will be apparent to one of skilled in the art that the inventive concepts may be practiced without one or more of these specific details.

### Overview

Embodiments disclosed herein include a personalized routines management system that includes a routines management application that generates and stores, from speech portions provided by a user within a vehicle, personalized routines for a vehicle to perform. The personalized routines management system also includes a hybrid inference engine that responds to the stored personalized routines by causing components of the vehicle to perform actions specified when specific conditions are met. A processing unit included in the personalized routines management system operates to receive one or more input auditory speech signals corresponding to phrase portions spoken by a user requesting to generate a personalized routine. The processing unit generates an intent from the phrase portions, where the intent includes a context portion detailing one or more conditions and an action portion detailing one or more actions to perform when the context portion is satisfied. The processing unit validates the intent with a set of pre-existing conditions the vehicle is capable of monitoring and a set of actions the vehicle is capable of performing in response to a trigger. The processing unit generates the personalized routine upon validation and, in various embodiments, converts the personalized routine into a format (e.g., a rule) that inference engine can interpret.

The processing unit also operates to monitor a set of vehicle conditions and determine whether the set of vehicle conditions satisfy any personalized routine. In some embodiments, the processing unit operates an inference engine, such as a hybrid inference engine, which compares vehicle conditions to a set of stored rules corresponding to the personalized routines. When the processing unit detects a change in a vehicle condition, the processing unit compares the current set of vehicle conditions to a set of stored personalized routines to determine whether the conditions specified in one of the personalized routines are met. When the processing unit determines that the conditions of a personalized routine are satisfied, the processing unit identifies the set of actions specified in the personalized routine and causes the applicable components of the vehicle to perform the specified actions.

### System Overview

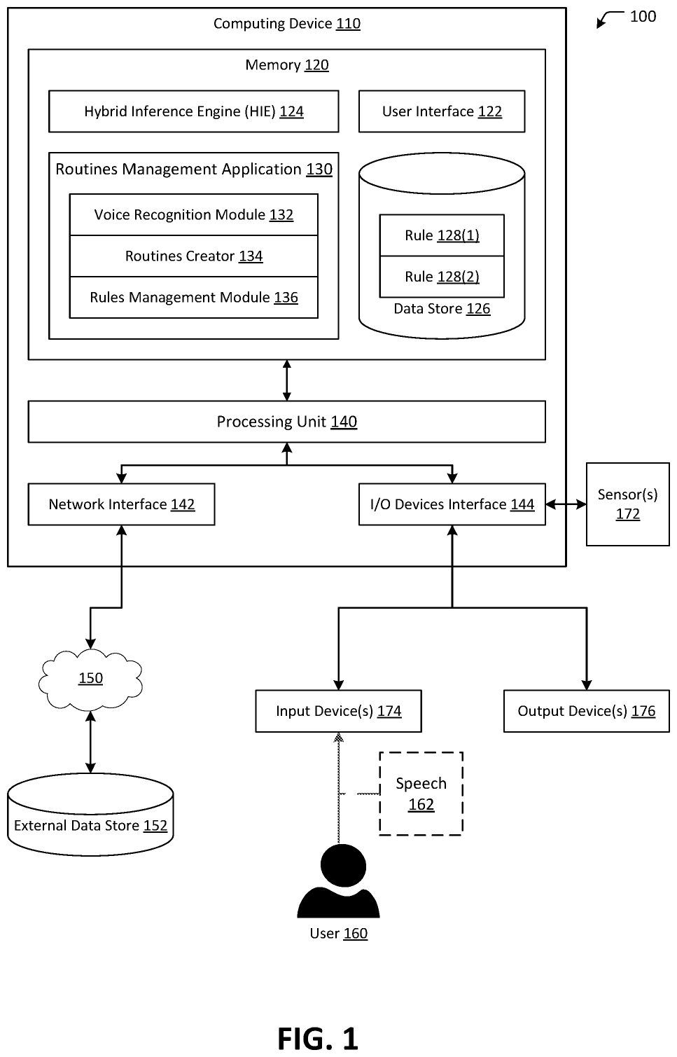

FIG. 1 illustrates a personalized routines management system 100 according to one or more embodiments. As shown, the personalized routines management system 100 includes, without limitation, a computing device 110, a network 150, an external data store 152, sensor(s) 172, input device(s) 174, and output device(s) 176. The computing device 110 includes, without limitation, a memory 120, a processing unit 140, a network interface 142, and an input/output (I/O) devices interface 144. The memory 120 includes, without limitation, a user interface 122, a hybrid inference engine (HIE) 124, a data store 126, and a routines management application 130. The routines management application 130 includes, without limitation, a voice recognition module 132, a routines creator 134, and a rules management module 136. The data store includes rule(s) 128 (e.g., 128(1), 128(2), etc.).

For explanatory purposes, multiple instances of like objects are denoted with reference numbers identifying the object and additional number in parentheses identifying the instance where needed. Further, the personalized routines management system 100 includes multiple instances of elements, even when not shown. For example, the personalized routines management system 100 can include multiple sensors 172 (e.g., 172(1), 172(2), 172(3), etc.), input devices 174 (e.g., 174(1), 174(2), 174(3), etc.), and/or output devices 176 (e.g., 176(1), 176(2), 176(3), etc.), and still be within the scope of the disclosed embodiments.

In operation, the computing device 110 executes the routines management application 130 in order to generate and store one or more rules 128 corresponding to personalized routines that the user specifies using one or more speech portions 162. In some embodiments, routines management application 130 receives, via the user interface 122, one or more speech portions 162 that specify a conditional statement corresponding to a desired routine; alternatively, in some embodiments, the routines management application 130 receives the one or more speech portions 162 separately by providing prompts to the user for specific types of speech portions (e.g., a request for a condition, a request for a vehicle action, etc.). Upon receiving the speech portions, the voice recognition module 132 processes the one or more speech portions 162 to generate an intent of the user. The routines creator 134 validates the contents of the intent against a set of pre-defined conditions and/or a set of pre-defined actions and generates a routine upon determining that the conditions and actions included in the intent are valid. In some embodiments, the routines management application 130 compares the generated routines with stored routines to determine whether this is an overlap; upon determining that the generated routine overlaps with an existing routine, the routines management application 130 can refrain from storing the generated routine or replace the conflicting routine. In various embodiments, the rules management module 136 can convert the routine into a different format, such as a rule 128 of a specific type (e.g., a C Language Integrated Production System (CLIPS) rule) before checking for overlaps and/or storing the rule 128.

The hybrid inference engine (HIE) 124 monitors various vehicle conditions that are associated with the operation of the vehicle or applications operating within the vehicle (e.g., vehicle state, environmental conditions, application events, etc.) via one or more vehicle components (e.g., one or more input devices 174). In various embodiments, the HIE 124 can respond to a detected change in a condition by comparing the current set of conditions to the rules 128 to determine whether the conditions of a given rule 128 (e.g., the rule 128(1)) are satisfied. Upon determining that the conditions specified by the rule 128(1) are satisfied, the HIE 124 determines one or more actions specified by the rule 128(1) and causes the corresponding vehicle component (e.g., one or more output devices 176) to perform the one or more actions specified by the rule 128(1).

The computing device 110 can include the processing unit 140 and the memory 120. In various embodiments, the computing device 110 can be a device that includes one or more processing units 140, such as a system-on-a-chip (SoC). In various embodiments, the computing device 110 can be a mobile computing device, such as a tablet computer, mobile phone, media player, and so forth that wirelessly connects to other devices in the vehicle. In some embodiments, the computing device 110 can be a head unit or part of a head unit included in a vehicle system. In some embodiments, the computing device 110 can be split among multiple physical devices in one or more locations. For example, one or more remote devices (e.g., cloud servers, remote services, etc.) can perform one or more aspects of the disclosed techniques, such as speech analysis, intent determination, rule generation, deduplication, and so forth. Additionally or alternatively, the computing device 110 can be a detachable device that is mounted in a portion of a vehicle as part of an individual console. Generally, the computing device 110 can be configured to coordinate the overall operation of the personalized routines management system 100. The embodiments disclosed herein contemplate any technically-feasible system configured to implement the functionality of the personalized routines management system 100 via the computing device 110. The functionality and techniques of the personalized routines management system 100 are also applicable to other types of vehicles, including consumer vehicles, commercial truck, airplanes, helicopters, spaceships, boats, submarines, and so forth.

The processing unit 140 can include one or more central processing units (CPUs), digital signal processing units (DSPs), microprocessors, application-specific integrated circuits (ASICs), neural processing units (NPUs), graphics processing units (GPUs), field-programmable gate arrays (FPGAs), and so forth. The processing unit 140 generally includes a programmable processor that executes program instructions to manipulate input data and generate outputs. In some embodiments, the processing unit 140 can include any number of processing cores, memories, and other modules for facilitating program execution. For example, the processing unit 140 could receive input from a user via the input devices 174 and generate pixels for display on an output device 176 (e.g., a display device). In some embodiments, the processing unit 140 can be configured to execute the routines management application 130 in order to create and store personalized routines based on speech portions 162 provided by the user 160 via an input device 174 (e.g., a microphone). Additionally or alternatively, the processing unit 140 can be configured to execute the HIE 124 in order to monitor a set of vehicle conditions and cause one or more vehicle components to execute a set of actions (e.g., vehicle behaviors, application events, etc.).

The memory 120 can include a memory module or collection of memory modules. The memory 120 generally comprises storage chips such as random access memory (RAM) chips that store application programs and data for processing by the processing unit 140. In various embodiments, the memory 120 can include non-volatile memory, such as optical drives, magnetic drives, flash drives, or other storage. In some embodiments, separate data stores, such as external data store 152 connected via the network 150 (“cloud storage”) can connect to the routines management application 130 and/or the HIE 124. The user interface 122, the HIE 124, and/or the routines management application 130 within the memory 120 can be executed by the processing unit 140 in order to implement the overall functionality of the computing device 110 and, thus, coordinate the operation of the personalized routines management system 100 as a whole.

In various embodiments, the routines management application 130 can implement one or more modules 132-136 to process the one or more speech portions 162 via the input device 174 in order to determine whether the user 160 provided contents for a valid personalized routine for the vehicle to perform and to store a version of the personalized routine (e.g., the rule 128(1)). When the routines management application 130 determines that the user 160 has provided valid conditions and actions for a valid personalized routine, the routines management application 130 stores the personalized routine as a rule 128(1) for the HIE 124 to monitor.

The voice recognition module 132 performs various natural language processing (NLP) and natural language understanding (NLU) techniques, sentiment analysis, and/or speech analysis in order to identify phrases spoken by the user 160. In some embodiments, the voice recognition module 132 receives the speech portions 162 from the user 160 via the user interface 122. Alternatively, in some embodiments, another component of the vehicle (e.g., an infotainment system, and entertainment subsystem, etc.) or another device, (e.g., a connected digital assistant) can process the speech portion 162. Additionally or alternatively, the voice recognition module 132 can perform various speech-to-text techniques on the speech portion 162 to classify the phrase as a portion of an intent.

In various embodiments, the voice recognition module 132 can determine a semantic meaning of a speech portion 162 made by the user 160 in order to determine whether the provided speech portion 162 is a portion of a valid routine. Alternatively, in some embodiments, another component of the vehicle or another device can generate the intent and/or other parameters of the speech portion 162. In such instances, the voice recognition module 132 can determine the semantic meaning of the intent and can modify the intent to include the determine semantic meaning. In some embodiments, the voice recognition module 132 performs sentiment analysis to determine an intent of a phrase and/or a meaning of a phrase. In some embodiments, the voice recognition module 132 can employ various statistical methods, machine-learning (ML) methods, state machines, and/or various other data structures in order to identify deviations of phrases spoken by the user 160 to pre-defined conditions or pre-defined actions associated with the vehicle.

The routines creator 134 generates a routine based on the intent provided by the voice recognition module 132. In various embodiments, the routines creator 134 can compare portions of the intent and/or other parameters associated with the speech portions 162 provided by the user 160 with one or more pre-defined conditions and/or one or more pre-defined actions to determine whether the user is attempting to create a valid personalized routine. For example, the user 160 can provides the speech portion, “Create Routine: when the song ‘Definition’ by Black Star starts, turn up the bass.” In such instances, the routines creator 134 can receive an intent specifying the context portion and the action portion phrase.
{IF current track=“Definition” AND current artist=‘Black Star’}
{THEN cause equalizer to increase BASS by 2}

Here, the “IF” parsed version of the speech portion 162 corresponds to the context portion and the “THEN” parsed version of the speech portion 162 corresponds to the action portion. The routines creator 134 can determine whether the HIE 124 is capable of monitoring the specified conditions by determining whether any pre-defined conditions monitor the current track and artist that the entertainment system of the vehicle is playing. The routines creator 134 can also determine whether the HIE 124 is capable of causing the entertainment system to change the equalizer settings in the manner specified by the user 160. In some embodiments, the voice recognition module 132 and/or the routines creator 134 can substitute specific values in the intent based on the determined semantic meaning. For example, the voice recognition module 132 can use NLU processes to determine that “turn up the bass” corresponds to valid actions such as increasing the bass level from the current level or setting the bass level to a specific level.

In various embodiments, when the routines creator 134 validates the intent, the routines creator 134 can generate a draft personalized routine and provide the draft routine to the user (e.g., dictating the contents of the draft routine, displaying a summary of the draft routine, etc.) for approval. Additionally or alternatively, when the routines creator 134 does not validate the intent, the routines creator 134 can provide a notification indicating that the user 160 did not provide contents for a valid personalized routine and can suggest that the user 160 try again or can enter into a guided mode.

When the routines management application 130 enters a guided mode, the routines management application 130 exchanges dialog with the user 160 by providing prompts for the user to provide speech portions 162 that correspond to a valid context portion or a valid action portion. In such instances, the routines management application 130 can list the vehicle components that are associated with pre-existing conditions or actions. For example, the routines management application 130 can initiate the guided mode by providing a prompt, “please provide a condition to check. The vehicle currently monitors the heating and cooling system, the power windows, and the media player.” The routines management application 130 can then receive a first speech portion 162(1) and can compare the first speech portion with the list of pre-existing conditions to validate the first speech portion 162 as specifying a valid context portion before providing an additional prompt. In such instances, the prompt could request a valid vehicle action, “please provide an action for the vehicle to perform. The vehicle currently controls the door locks, the equalizer, and the power windows.” The routines management application 130 can then receive a second speech portion 162(2) and can compare the second speech portion with the list of pre-existing actions to validate the second speech portion 162 as specifying a valid action portion. Upon validating the contents of the separate speech portions 162(1), 162(2), the routines creator 134 can generate a draft personalized routine that includes the context portion and the action portion.

The rules management module 136 converts the draft personalized routine into a rule that the HIE 124 can monitor. In various embodiments, the rules management module 136 can convert the context portion and action portion of a personalized routine into a rule 128 having a specific format. For example, a CLIPS rule can include a facts portion and an action portion. In various embodiments, the HIE 124 can monitor information of one or more services provided by the vehicle (e.g., vehicle states and conditions, monitored environmental conditions, application states and events, etc.) to determine whether a given fact of a rule is true (e.g., determine whether the fact “there is precipitation on the vehicle” is currently true based on information provided by the sensors 172). When the HIE 124 determines that the facts for a given rule 128 are valid, the HIE 124 performs the action included in the rule.

In various embodiments, the rules management module 136 can communicate with the HIE 124 and/or other modules when generating the rule 128 from the personalized routine. For example, the rules management module 136 can refer to a use case interface and/or a service interface to determine the applicable identifiers for systems and/or devices associated with a rule 128. In some embodiments, the rules management module 136 can forward the personalized routine to a separate code generator that generates the rule 128 from the personalized routine. Additionally or alternatively, the rules management module 136 can store the rule 128 in a local data store 126.

The user interface 122 enables the user 160 to provide input(s) about specific data, such as the speech portions 162, approval of draft personalized routines, and so forth. In some embodiments, the user interface 122 can receive inputs indicating remotely-stored rules (e.g., stored in the external data store 152) to download. Additionally or alternatively, the user interface 122 displays text corresponding to the pre-existing conditions, pre-existing actions, example, use cases, and/or notifications of errors (e.g., invalid intents, duplicate or overlapping rules, etc.). In some embodiments, user interface 122 can take any feasible form for providing the functions described herein, such as one or more buttons, toggles, sliders, dials, knobs, etc., or as a graphical user interface (GUI).

In various embodiments, the user interface 122 can be provided through any component of personalized routines management system 100. In one embodiment, user interface 122 can be provided by a separate computing device that is communicatively coupled with computing device 110, such as through an application running on a user's mobile or wearable computing device. Additionally or alternatively, an infotainment system (e.g., included in an entertainment subsystem of a vehicle head unit) can provide the user interface 122 via a display and/or a voice digital assistant. In another example, user interface 122 can receive verbal commands for user selections. In this case, computing device 110 can perform speech recognition on the received verbal commands and/or compare the verbal commands against commands stored in the memory 120. After verifying the received verbal commands, computing device 110 could then execute the commanded function for the personalized routines management system 100.

The hybrid inference engine (HIE) 124 is an in-vehicle inference service that receives information about one or more services that the vehicle is operating and causes actions to be performed by the vehicle. In various embodiments, the HIE 124 can be an inference engine that applies logical rules from a set of determined facts. In some embodiments, the HIE 124 can include a HIE service application that communicates with other components of the vehicle and a HIE framework that includes modules that process information associated with locally-stored rules 128 and existing conditions and/or existing actions that can be included in valid rules 128.

In various embodiments, the HIE 124 can receive various signals indicating various vehicle conditions or states as facts from which the HIE 124 applies logical rules (e.g., the rules 128). In various embodiments, the HIE 124 can receive a set of current vehicle conditions and can compare the set of vehicle conditions to the stored rules 128 to determine whether the conditions of a given rule 128 have been satisfied (e.g., the facts of a given rule are true). In some embodiments, the HIE 124 can process several types of logical rules, such as CLIPS rules.

In various embodiments, the HIE 124 responds to a determination that a rule 128(1) is applicable by identifying one or more actions specified in the rule 128(1). Upon identifying the one or more actions, the HIE 124 can generate one or more commands to cause the applicable systems to perform the specified actions. For example, upon determining that a triggering event occurred to satisfy a rule 128(2), the HIE 124 can identify the specified action as closing the windows. The HIE 124 can then transmit a command to a separate vehicle subsystem that causes the vehicle subsystem to close any window that was open.

The data store 126 store values and other data retrieved by the processing unit 140 to coordinate the operation of the personalized routines management system 100. In various embodiments, in operation, the processing unit 140 can be configured to store values in the data store 126 and/or retrieve values stored in the data store 126. For example, the data store 126 could store sensor data, audio content (e.g., audio clips, speech portions, etc.), a personalized routine table, and/or one or more created rules 128.

In some embodiments, the computing device 110 can communicate with other devices, such as the sensor(s) 172, the input device(s) 174, and/or the output device(s) 176, using the input/output (I/O) devices interface 144. In such instances, the I/O devices interface 144 can include any number of different I/O adapters or interfaces used to provide the functions described herein. For example, the I/O devices interface 144 could include wired and/or wireless connections, and can use various formats or protocols. In another example, the computing device 110, through the I/O devices interface 144, could receive auditory signals from the input device(s) 174, can detect physiological data, visual data, and so forth using the sensor(s) 172, and can provide output signals to the output device(s) 176 to produce outputs in various types (e.g., visual indication, soundwaves, haptic sensations, etc.).

In some embodiments, the computing device 110 can communicate with other devices, such as the external data store 152, using the network interface 142 and the network 150. In some embodiments, other types of networked computing devices (not shown) can connect to the computing device 110 via the network interface 142. Examples of networked computing devices include a server, a desktop computer, a mobile computing device, such as a smartphone or tablet computer, and/or a worn device, such as a wristwatch or headphones or a head-mounted display device. In some embodiments, the networked computing devices can be used as the sensor(s) 172, the input device(s) 174, and/or the output device(s) 176.

The network 150 includes a plurality of network communications systems, such as routers and switches, configured to facilitate data communication between the computing device 110 and the external data store 152. Persons skilled in the art will recognize that many technically-feasible techniques exist for building the network 150, including technologies practiced in deploying an Internet communications network. For example, the network 150 can include a wide-area network (WAN), a local-area network (LAN), and/or a wireless (Wi-Fi) network, among others.

The external data store(s) 152 include various libraries that provide several types of information. For example, the external data stores 152 can include backends for search engines, mapping data, and so forth. Additionally or alternatively, the external data store(s) 152 can include additional services in the form of additional conditions that the HIE 124 can monitor and/or action that the HIE 124 can cause to be performed. In such instances, the personalized routines management system 100 can expand capabilities by downloading additional services from the external data store(s) 152.

The sensor(s) 172 include one or more devices that collect data associated with objects in an environment. In various embodiments, the sensor(s) 172 can include groups of sensors that acquire different sensor data. For example, the sensor(s) 172 could include a reference sensor, such as a microphone and/or a visual sensor (e.g., camera, thermal imager, linear position sensor, etc.), which could acquire auditory data, visual data, physiological data, and so forth.

In various embodiments, the sensor(s) 172 and/or the input device(s) 174 can include audio sensors, such as a microphone and/or a microphone array that acquires sound data. In various embodiments, the microphone can be directional (e.g., user-facing microphone, beamforming microphone array, etc.) and acquire auditory data from a specific person, such as the user 160. Such sound data can be processed by the personalized routines management system 100 and/or another audio processing device using various audio processing techniques. The audio sensors can include a plurality of microphones or other transducers or sensors capable of converting sound waves into an electrical signal. The audio sensors can include an array of sensors that includes sensors of a single type, or a variety of different sensors.

The sensor(s) 172 can include one or more devices that perform measurements and/or acquire data related to certain subjects in an environment. In various embodiments, the sensor(s) 172 can generate sensor data that is related to the user 160. For example, the sensor(s) 172 could collect biometric data related to the user 160 (e.g., visible perspiration, muscle movement, breathing rate, pupil size, eye saccades, temporary change in skin color, etc.). and/or the user 160 when speaking (e.g., heart rate, brain activity, skin conductance, blood oxygenation, galvanic skin response, blood-pressure level, average blood glucose concentration, etc.). Further, the sensor(s) 172 could include a user-facing camera that records the face of user 160 as image data. Similarly, the sensor(s) 172 could include a facial electromyography (fEMG) sensor that measures specific muscle contractions and associated activities (e.g., a raised eyebrow, clenched jaw, etc.), of user 160.

In another example, the sensor(s) 172 could include sensors that acquire biological and/or physiological signals of the user 160 when speaking (e.g., perspiration, heart rate, heart-rate variability (HRV), blood flow, blood-oxygen levels, breathing rate, galvanic skin response (GSR), sounds created by a user, behaviors of a user, etc.). Additionally, the sensor(s) 172 could include a pupil sensor (e.g., a camera focused on the eyes of user 160) that acquires image data about at least one pupil of the user 160. The personalized routines management system 100 could then perform various pupillometry techniques to detect eye parameters (e.g., fluctuations in the pupil diameter, eye gaze direction, eye lid position, eye saccades, etc.) as physiological data.

The input device(s) 174 are devices capable of receiving one or more inputs. In various embodiments, the input device(s) 174 can include one or more audio input devices, such as a microphone, a set of microphones, and/or a microphone array. In some embodiments, the input device(s) 174 can include other devices capable of receiving input, such as a keyboard, a mouse, a touch-sensitive screen, and/or other input devices for providing input data to the computing device 110. Such inputs could include gestures, such as various movements or orientations of the hands, arms, eyes, or other parts of the body that are received via a camera. Additionally or alternatively, the input device(s) 174 can include multiple types of sensors, including vehicle sensors (e.g., outward-facing cameras, accelerometers, etc.), occupant-facing sensors (e.g., cameras, microphones, motion sensors, etc.), and/or compartment non-occupant facing sensors (e.g., pressure sensors, temperature sensors, etc.). In various embodiments, the input device(s) 174 can provide a combination of sensor data that describes the context of the vehicle and the occupants that are present within the vehicle. For example, the sensors can provide a set of values associated with the users of the vehicle (e.g., positions of users, noise level, etc.).

The output device(s) 176 include devices capable of providing output, such as a display screen, loudspeakers, haptic output devices, and the like. For example, the output device 176 could be headphones, ear buds, a speaker system (e.g., one or more loudspeakers, amplifier, etc.), or any other device that generates an acoustic field. In another example, the output device 176 could include haptic output devices, such as ultrasound transducers, air vortex generators, air bladders, and/or any type of device configured to generate haptic output. In various embodiments, various input device(s) 174 and/or output device(s) 176 can be incorporated into computing device 110, or can be external to computing device 110.

In various embodiments, the output device(s) 176 can be implemented using any number of different conventional form factors, such as discrete loudspeaker devices, around-the-ear (circumaural), on-ear (supraaural), or in-ear headphones, hearing aids, wired or wireless headsets and/or personal speakers, body-worn (head, shoulder, arm, etc.) speaker devices, body-worn close-range directional speakers or speaker arrays, body-worn ultrasonic speaker arrays, and so forth. In some embodiments, output device(s) 176 include other forms of outputs, such as display devices that provide visual outputs. In some embodiments, output device(s) 176 can be worn by user 160, or disposed separately at a fixed location, or movable. Additionally or alternatively, the output device(s) 176 can include various components to control the operation of the vehicle. For example, the output device(s) 176 can include controllers to operate one or more windows, windshield wipers, locks, etc. In some embodiments, the output device(s) 176 can include various vehicle subsystems, such as the air conditioning subsystem, navigation subsystem, entertainment subsystem, and so forth. In such instances, the output device(s) 176 can receive commands and generate signals to cause a specific action (e.g., open the driver-side window) to be performed.

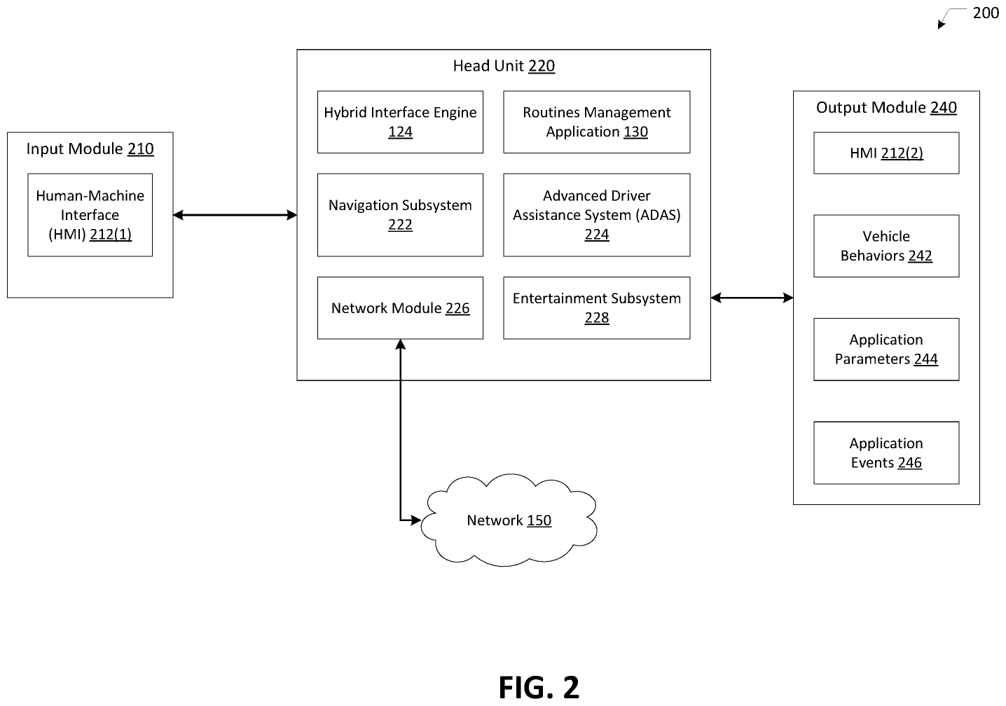

FIG. 2 illustrates an example vehicle system 200 that includes a routines management application 130 and a HIE 124 of FIG. 1, according to various embodiments. As shown, the vehicle system includes, without limitation, an input module 210, a head unit 220 and an output module 240. The input module includes a human-machine interface (HMI) instance 212(1). The head unit 220 includes, without limitation, the HIE 124, the routines management application 130, a navigation subsystem 222, an advanced driver assistance system (ADAS) 224, a network module 226, and an entertainment subsystem 228. The output module 240 includes an HMI instance 212(2), a set of vehicle behaviors 242, a set of application parameters 244, and a set of application events 246.

In various embodiments, the personalized routines management system 100 can be included in the vehicle system 200 in order to generate and store personalized routines locally for various components of the vehicle to perform. In various embodiments, the HIE 124 can monitor information from the one or more subsystems and can respond to a triggering event for a given rule 128 by causing one or more subsystems to perform an action. In various embodiments, the HIE 124 can cause a subsystem to perform an action in response to a condition associated with a different subsystem. For example, the HIE 124 can receive information from the navigation subsystem and can respond to the applicability of a rule 128 by controlling one or more components of the entertainment subsystem 228.

The input module 210 can include an HMI instance 212(1) that includes the user interface 122. In such instances, the user 160 can provide inputs by providing the speech portions 162. In some embodiments, the user 160 can provide other inputs via the HMI 212(1), such as button presses and/or digital inputs to initiate the routine creation process, confirm approval of a personalized routine, and/or the like.

The head unit 220 is a component of the vehicle system 200 that is mounted at any location within a passenger compartment of the vehicle in any technically-feasible fashion. In some embodiments, the head unit 220 can include any number and type of instrumentation and applications and can provide any number of input and output mechanisms. For example, the head unit 220 can enable users (e.g., the driver and/or passengers) to control the navigation subsystem 222 and/or the entertainment subsystem 228. The head unit 220 supports any number of input and output data types and formats, as known in the art. For example, the head unit 220 could include built-in Bluetooth for hands-free calling and/or audio streaming, universal serial bus (USB) connections, speech recognition, rear-view camera inputs a sensing module, video outputs via the output module 240 for any number and type of displays, and any number of audio outputs. In general, any number of sensors (e.g., sensors 172), displays, receivers, transmitters, etc., can be integrated into the head unit 220, or can be implemented externally to the head unit 220. In various embodiments, external devices can communicate with the head unit 220 in any technically-feasible fashion.

The entertainment subsystem 228 provides various information to the controlling user and/or one or more other occupants of the vehicle via the output module 240. For example, the head unit 220 could provide to the driver route information associated with the vehicle via the HMI 212. In various embodiments, the HIE 124 can control various components associated with the entertainment subsystem 228, such as media sources (e.g., internal sources or external media providers via the network module 226) and/or the output devices (e.g., output devices 176, speakers, displays, and/or the HMI 212) included in the output module 240 and/or other vehicle components. In some embodiments, the network module 226 can transmit data acquired by head unit 220. Additionally or alternatively, one or more modules connected to the head unit 220 can receive data from remote sources via the network module 226.

The output module 240 performs one or more actions in response to commands from the HIE 124 and/or the routines management application 130. For example, the output module 240 can generate one or more output signals that causes an application and or other vehicle component to perform an action. For example, output module 240 could generate one or more output signals to modify the HMI 212(2) to display notification messages and/or alerts or cause the vehicle to perform a specific vehicle behavior 242. For example, the vehicle behaviors 242 could include vehicle climate control settings (e.g., window controls, passenger compartment temperature, increasing fan speed, etc.), and/or olfactory parameters, such as emitting specific fragrances that are calming or stimulating. In various embodiments, the vehicle behaviors 242 can include emergency calling parameters, such as triggering the dialing of one or more emergency phone numbers or suggesting that the user connect to specific contact situations that can require immediate assistance and/or response. In another example, the output module 240 could generate one or more output signals to modify an application. In such instances, the output signal can include application parameters 244 and/or application events 246.

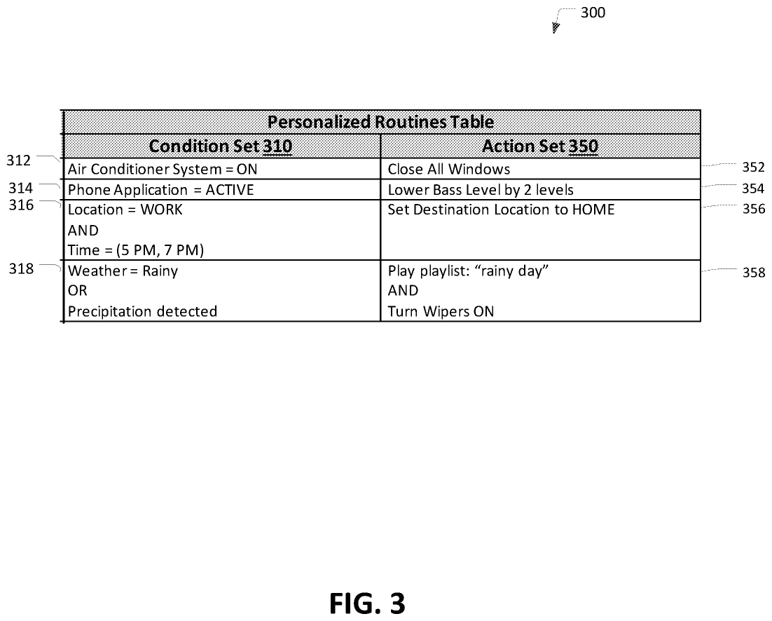

FIG. 3 illustrates an example personalized routines table 300 included in the personalized routines management system 100 of FIG. 1, according to various embodiments. As shown, and without limitation, the personalized routines table 300 includes a column 310 for stored context portions of rules 128 and a column 350 for stored actions portions of rule 128. The personalized routines table 300 includes a set of stored condition sets 312-318 and a set of action sets 352-358.

The routines management application 130 can generate a personalized routine (e.g., stored condition set 312 and stored action set 352) and can store the personalized routine in a specific format, such as a CLIPS rule. In other embodiments, the routines management application 130 can store the personalized routines outside of a table.

For the first entry, the routines management application 130 can generate a personalized routine in response to a one-shot speech portion 162 that includes both parts of a conditional statement and a phrase indicating the request to create a new rule. For example, the user 160 can state, “Create Routine: when I turn the AC on, make sure all the windows are closed.” The routines management application 130 can perform various NLU techniques to determine the semantic meaning and generate an intent that identifies the air conditioner system as a system providing state information to the HIE 124 and the specific condition for the system (“ON”). The routines management application 130 can also identify a specific action that one or more vehicle components can take to cause the windows to be in the specified state. When the vehicle is in operation, the HIE 124 can receive vehicle behaviors that indicate the state of the air conditioner system. When the HIE 124 detects a change (e.g., OFF to ON), the HIE 124 determines that the condition 312 has been satisfied and identifies the specified action 352. Upon identifying the specified action 352, the HIE 124 can generate commands to cause the vehicle to close any open windows.

For the second entry, the routines management application 130 can generate a personalized routine based on a preference of the user 160 to minimize the bass level of audio when conducting a call. For example, the user 160 can speak a request to change the bass level when on a phone call. The routines management application 130 can respond by generating a condition 314 based on a state associated with the phone application and a corresponding action 354 for the entertainment subsystem 228 to perform. During operation, the HIE 124 can receive vehicle conditions that includes information associated with an application event (e.g., phone application open, call occurring, call ended, etc.) and upon determining that the condition 314 has been satisfied, identifies the corresponding action 354 and generates an applicable command to cause the entertainment subsystem 228 to modify the bass level.

For the third entry, the routines management application 130 can store a routine that includes a condition set 316 of two or more conditions. In various embodiments, the routine can include various Boolean operators (e.g., AND, OR, XOR, etc.) to combine the two or more conditions. In operation, the HIE 124 can receive a set of vehicle conditions from various systems (e.g., the navigation subsystem 222, an internal clock, etc.) that and can determine whether both conditions in the condition set 316 are satisfied. When the HIE 124 determines that the condition set 316 is satisfied, the HIE 124 generates a command corresponding to the action 356, where the navigation subsystem sets a specific location (e.g., a stored ‘HOME’ location) as a destination for a navigation route.

For the fourth entry, the routines management application 130 can store a routine that includes a condition set 318 including two or more conditions and an action set 358 including two or more actions. In operation, the HIE 124 can compare a current set of vehicle conditions to the condition set 318 and determine whether either of the conditions in the condition set 318 are satisfied. When the HIE 124 determines that the condition set 318 is satisfied, the HIE 124 identifies each action in the action set 358 and generates commands that cause applicable vehicle subsystems to perform the specified actions.

### In-Vehicle Generation of Personalized Routines

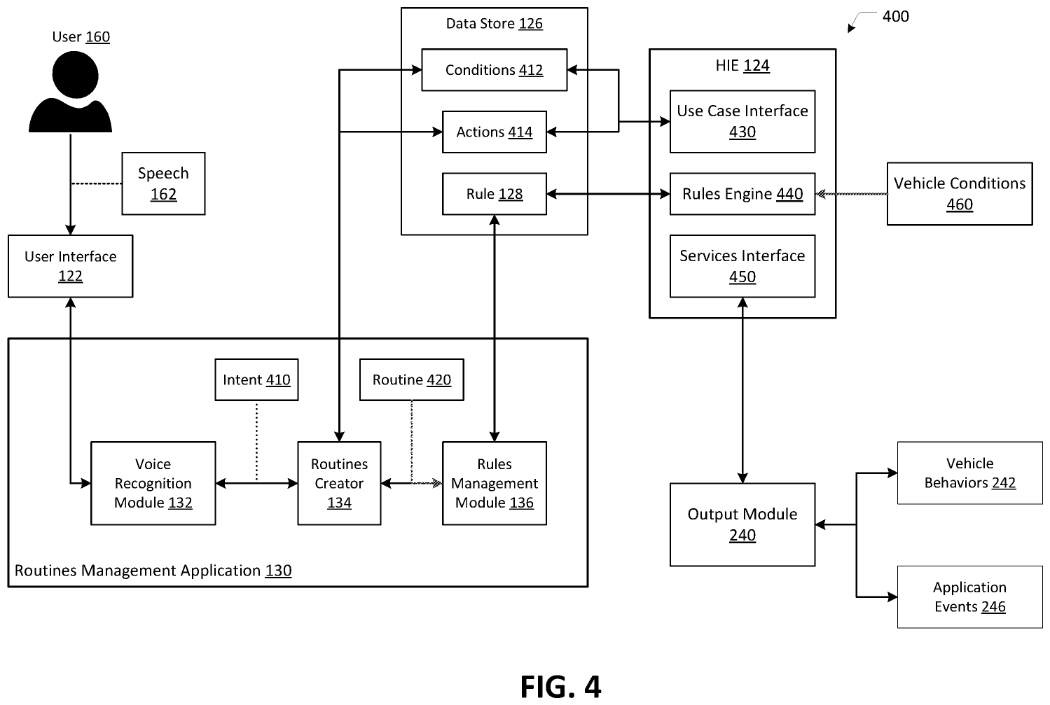

FIG. 4 illustrates a technique of the personalized routines management system 100 of FIG. 1 creating a stored rule 128 and responding to a triggering of the stored rule 128, according to various embodiments. As shown, the personalized routines management system 400 includes, without limitation, the user interface 122, the routines management application 130, the HIE 124, the data store 126, and the output module 240. The routines management application 130 includes, without limitation, the voice recognition module 132, the routines creator 134, the rules management module 136, an intent 410, and a routine 420. The data store includes, without limitation, a set of conditions 412, a set of actions 414, and a set of rules 128. The HIE 124 includes, without limitation, a use case interface 430, a rules engine 440, and a services interface 450.

In operation, the routines management application 130 can create a routine 420 based on an intent 410 derived from the one or more speech portions 162 provided by the user 160. The routines management application 130 can generate a rule 128 corresponding to the routine 420 and can store the rule 128 in the data store. During subsequent operations, the HIE 124 can receive various vehicle conditions 460 and can determine whether any of the vehicle conditions satisfy the rule 128. When the HIE 124 determines that the vehicle conditions satisfy the rule 128, the HIE 124 identifies one or more actions specified by the rule 128 and transmits commands to the output module 240. The output module 240 performs the specified actions that cause one or more vehicle behaviors and/or one or more application events 246.

In various embodiments, the voice recognition module 132 generates the intent 410 from the one or more speech portions 162. In some embodiments, the voice recognition module 132 can receive one or more speech portions 162 provided by the user via the user interface 122. In such instances, the voice recognition module 132 can parse the speech portions 162 and generate the intent 410. The intent 410 can include various fields that specify the intention of the user to generate a personalized routine. For example, the intent 410 can include a context field that includes information associated with conditional statements for a routine, and an action field that includes information associated with action statements for a routine. In some embodiments, the voice recognition module 132 can perform various speech-to-text techniques to generate text that is included in the intent.

The routines creator 134 responds to receipt of the intent 410 by validating the contents of the intent 410 using sets of pre-existing information related to the capabilities of the vehicle system 200. For example, the routines creator 134 can refer to the set of conditions 412 to determine whether the contents of the context field match one or more of the set of conditions 412. Similarly, the routines creator 134 can refer to the set of existing actions to determine whether the content of the actions field match one or more of the set of actions 414. In some embodiments, the set of conditions 412 and/or the set of actions 414 can be stored in a resource file that the HIE 124 maintains via the use case interface 430. For example, the use case interface 430 can include a set of generic routines, a set of pre-defined use cases, and/or other personalized use cases from which the set of conditions 412 and/or the set of actions 414 can be derived. In another example, the services interface 450 can maintain a list of available services and the corresponding conditions and actions associated with the available services.

When the routines creator 134 successfully validates the intent 410, the routines creator 134 generates a routine 420 by mapping the content of the intent 410 to the identified condition and/or the identified action. Upon creating the routine 420, the routines creator 134 presents the routine 420 to the user 160 for approval. Otherwise, when the routines creator 134 does not validate the intent 410, the routines creator 134 provides a notification message to the user indicating that the user 160 requested the creation of an invalid routine.

In some embodiments, the routines creator 134 can store the routine 420 in the data store 126. Additionally or alternatively, in various embodiments, the rules management module 136 can convert the routine 420 into a rule 128. For example, the rules management module 136 can transmit the routine 420 to a code generator (not shown) that generates the rule 128. In such instances, the rule 128 can be in a specific format (e.g., a CLIPS rule, a .JavaScript Object Notation (JSON) file, etc.) that the HIE 124 can process.

In some embodiments, the rules management module 136 can provide the currently-generated rule to the HIE 124, where the rules engine 440 determines whether the currently-generated rule 128 overlaps an existing rule (e.g., the currently-generated rule 128 is a duplicate of an existing rule, the currently-generated rule 128 contradicts an existing rule, etc.). When the rules engine 440 determines that the currently-generated rule 128 does not overlap an existing rule, the rules engine 440 causes the rules management module 136 to store the rule 128 in the data store 126. Otherwise, when the rules engine 440 determines that the currently-generated rule 128 overlaps with an existing rule, the rules engine 440 stops the rules management module 136 from storing the rule 128 in the data store 126 and generates an error message indicating that the rule 128 will not be stored and the reason (e.g., duplicate). For example, when the rule engine 440 determines the rule 128 is a duplicate, the rules engine 440 can notify the user 160 that the user 160 that the rule 128 will not be stored and to start again. In another example, when the rules engine 440 determines that the rule 128 contradicts an existing rule, the rules engine 440 can provide a prompt with various options for the user 160 to respond, such as by replacing a characteristic of the rule 128 (e.g., change the specified action, change the condition, etc.), replacing the existing rule, or starting again to generate a different rule 128.

In various embodiments, the HIE 124 can receive vehicle conditions 460 associated with the operation of the vehicle. In such instances, the HIE 124 can determine whether the received vehicle conditions 460 satisfy the rule 128. When the HIE 124 determines that the rule 128 has been satisfied, the HIE 124 generates commands for the output module 240 to perform certain actions in the form of vehicle behaviors 242 and/or application events 246.

In various embodiments, the rules engine 440 can receive the vehicle conditions 460 from one or more vehicle components. In some embodiments, the rules engine 440 can receive a subset of the vehicle conditions 460 at times when a value associated with a vehicle condition changes. For example, when a system changes state (e.g., the air conditioner system transitions from OFF to ON), the rules engine can receive a subset of vehicle conditions 460 that includes the updated state of the air conditioner system. Additionally or alternatively, the rules engine 440 can periodically receive the vehicle conditions 460. The vehicle conditions 460 can include various values monitored by the vehicle components (e.g., environmental, physiological, and/or other data acquired by the sensors 172), information associated with applications that a vehicle component is running (e.g., information associated with content items that the entertainment subsystem 228 is playing via a media player), vehicle component states, and so forth.

The rules engine 440 compares the vehicle conditions 460 to the rules 128 stored in the data store 126. In various embodiments, the rules engine 440 can compare the information in the vehicle condition 460 with various condition sets 312-318 to determine whether any of the condition sets 312-318 have been satisfied. When the rules engine 440 detects that a specific condition set (e.g., the condition set 318) has been satisfied, the rules engine 440 identifies the action set (e.g., the action set 358) that of the rule 128 that has been satisfied.

In various embodiments, the services interface 450 can generate one or more commands for a specific service that is to perform an action specified by the rule 128. For example, when causing vehicle components to perform the action set 358, the services interface 450 can identify the entertainment subsystem 228 as the applicable service and can generate a command to cause the entertainment subsystem 228 to change the playlist. Similarly, the services interface 450 can identify the vehicle subsystem controlling the windshield wipers and generate a command to cause the windshield wipers to activate.

The output module 240 receives the one or more commands from the services interface 450 and causes the applicable vehicle component to the perform the command. Following the example from above, the output module 240 can transmit a command to the entertainment subsystem 228 to perform the specific application event 246 of playing a specific playlist. The output module 240 can also transmit a command to the wiper controls to cause the vehicle behavior 242 to change by activating the wipers.

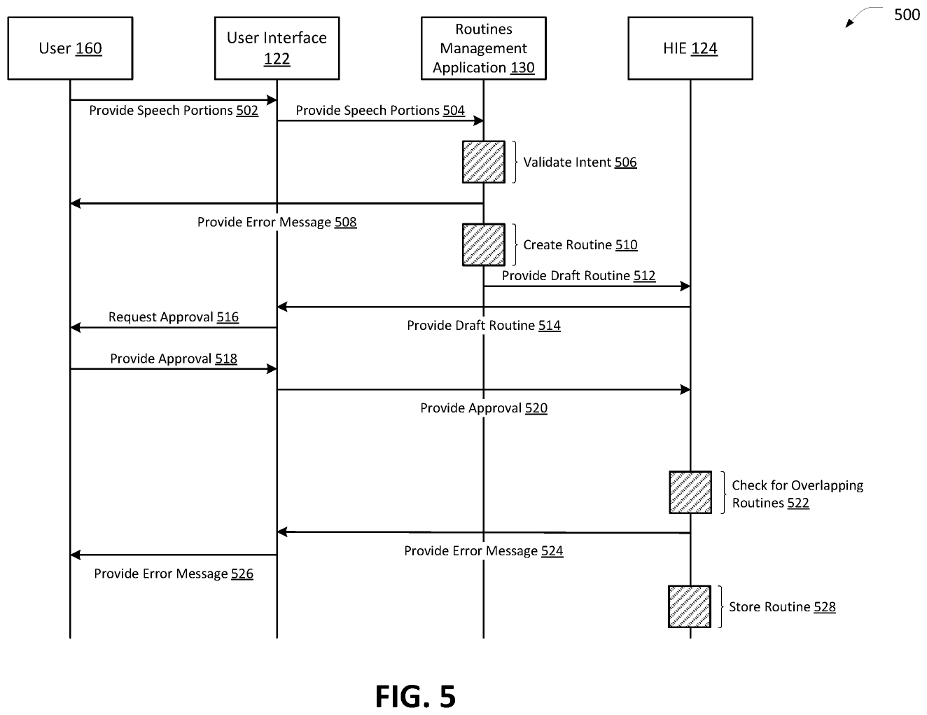

FIG. 5 illustrates an interaction diagram 500 between various components of the personalized routines management system 100 of FIG. 1, according to various embodiments. Although the interactions between devices are shown in an order, persons skilled in the art will understand that the interactions can be performed in a different order, interactions can be repeated or skipped, and/or can be performed by components other than those described in FIG. 5.

As shown in FIG. 5, the user 160 provides 502 the speech portions 162 to the user interface 122. In various embodiments, the user 160 can provide one or more speech portions 162 to the user interface when requesting that the routines management application 130 create a personalized routine. In some embodiments, the user 160 creates the personalized routine using a single utterance that includes a speech portion 162 that having a conditional statement specifying the context and action for the routine. Alternatively, in some embodiments, the user interface 122 can provide one or more prompts (not shown) to cause the user to provide the speech portions 162 that include the context portion and action portion. The user interface 122 provides 504 the speech portions 162 to the routines management application 130.

The routines management application 130 performs action 506 to validate an intent 410 corresponding to the speech portions 162. In various embodiments, the routines management application 130 can generate an intent 410 that includes a context field whose contents include (i) one or more conditions and (ii) one or more actions corresponding to the speech portions 162. In various embodiments, the routines management application 130 can validate the intent 410 by comparing the contents of the intent 410 with sets of conditions 412 and/or sets of actions 414 that the personalized routines management system 100 is capable of determining and performing, respectively.

When the routines management application 130 does not successfully validate the intent 410, the routines management application 130 provides 508 an error message to the user indicating that the requested routine was not valid. Otherwise, when the routines management application 130 successfully validates the intent 410, the routines management application 130 creates 510 a routine 420 corresponding to the intent 410. In various embodiments, the routines management application 130 can generate a routine by mapping the content of the intent 410 to one or more of the conditions 412 and/or one or more of the actions 414.

In various embodiments, upon creating the routine 420, the routines management application 130 can provide 512 the routine 420 to the HIE 124. The HIE 124 can then provide 514 the routine 420 to the user interface 122, which requests approval 516 from the user 160 to store the routine 420. In various embodiments, the user interface 122 can request approval 516 in various formats, such as by dictating the routine 420 via a loudspeaker, displaying the routine 420 via a display device, etc. When the user 160 reviews and approves the routine 420, the user 160 can provide approval 518 to the user interface 122. In some embodiments, the approval provided by the user 160 can be in a different format than the request for approval 516. For example, the user interface 122 can display the routine 420 and a prompt requesting approval. The user 160 can then speak a speech portion 162 indicating approval to the user interface 122. When the user interface 122 receives the approval, the user interface provides 520 the approval to the HIE 124.

In various embodiments, the HIE 124 can perform various actions 522 to check whether the routine 420 overlaps with existing routines that are locally stored in the data store 126. In some embodiments, the routines management application 130 can convert the routine 420 into a rule 128. In such instances, the HIE 124 can compare the rule 128 corresponding to the approved routine 420 to existing rules 128 stored in the data store 126. In some embodiments, the HIE 124 can determine whether the routine 420 is a duplicate of an existing routine or whether the routine 420 contradicts an existing routine 420. For example, a user can approve a routine 420 to respond to the air conditioner turning on by setting the volume level of the speakers to level 10. When the HIE 124 identifies an existing routine that responds to the air conditioner turning on by setting the volume to level 5, the HIE 124 can determine that the two routines overlap.

When the HIE 124 identifies at least one overlapping routine, the HIE 124 provides 524 an error message to the user interface 122. In various embodiments, the user interface 122 can then provide 526 an error message indicating that the routine 420 approved by the user 160 will not be stored, as well as the reason for the error (e.g., overlaps with existing routine). In some embodiments, the HIE 124 can provide a prompt with various options for the user 160 to respond to the overlap, such as by replacing a characteristic of the routine (e.g., change the specified action, change the condition, etc.), replacing the existing routine, starting again to generate a different routine, and so forth.

When the HIE 124 determines that the routine 420 does not overlap an existing routine, the HIE 124 performs various actions 528 to store the routine in the data store 126.

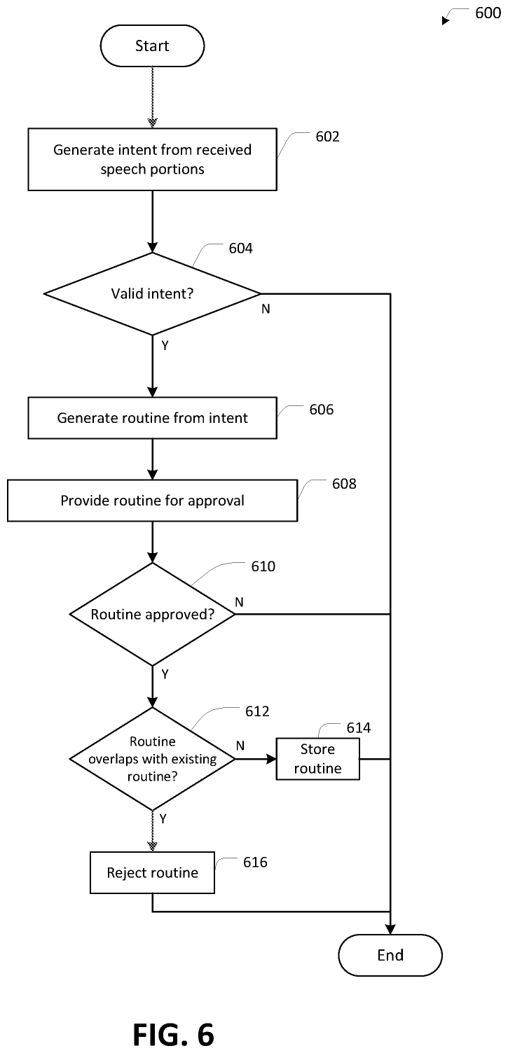

FIG. 6 sets forth a flow chart of method steps for generating a rule corresponding to a personalized routine specified by a user, according to various embodiments. Although the method steps are described with reference to the embodiments of FIGS. 1-5, persons skilled in the art will understand that any system configured to implement the method steps, in any order, falls within the scope of the present disclosure.

As shown in FIG. 6, the method 600 begins at step 602, where the routines management application 130 generates an intent 410 from one or more received speech portions 162. In various embodiments, the voice recognition module 132 included in the routines management application 130 generates the intent 410 from the one or more speech portions 162. In some embodiments, the voice recognition module 132 can receive one or more speech portions 162 provided by the user via the user interface 122. In such instances, the voice recognition module 132 can parse the speech portions 162 and generate the intent 410. The intent 410 can include various fields that specify the intention of the user to generate a personalized routine. For example, the intent 410 can include a context field that includes information associated with conditional statements for a routine, and an action field that includes information associated with action statements for a routine.

At step 604, the routines management application 130 determines whether the intent 410 is valid. In various embodiments, the routines creator 134 can responds to receipt of the intent 410 by validating the contents of the intent 410. In such instances, the routines creator 134 can refer to the set of conditions 412 to determine whether the contents of the context field included in the intent 410 match one or more condition in the set of conditions 412. Similarly, the routines creator 134 can refer to the set of actions 414 to determine whether the content of the actions field match one or more action in the set of actions 414. When the routines creator 134 successfully validates the intent 410, the routines management application 130 proceeds to step 608. Otherwise, when the routines creator 134 does not validate the intent 410, the routines management application 130 provides an error message and ends method 600.

At step 606, the routines management application 130 generates a routine 420 from the intent 410. In various embodiments, the routines creator 134 can generates a routine 420 by mapping the content of the intent 410 to the identified condition and/or the identified action used to validate the intent 410. At step 608, the routines management application 130 provides the routine 420 for approval. In various embodiments, upon creating the routine 420, the routines creator 134 presents the routine 420 to the user 160 for approval. At step 610, the routines management application 130 determines whether the user 160 approved the routine 420. When the routines management application 130 receives an indication that the user 160 approved the routine, the routines management application 130 proceeds to step 614. Otherwise, when the routines management application 130 determines that the user 160 did not approve the routine 420, the routines management application 130 ends the method 600.

At step 612, the routines management application 130 determines whether the routine 420. overlaps with an existing routine. In various embodiments, the routines management application 130 can check one or more stored routines stored in the data store 126 to determine whether the routine 420 overlaps with an existing routine. In some embodiments, the data store 126 can store the routines as a different format (e.g., one or more rules 128). In such instances, the routines management application 130 can convert the routine into the different format before checking for overlaps. Additionally or alternatively, the routines management application 130 can cause the HIE 124 to check for overlaps. When the routines management application 130 does not identify at least one overlapping routine, the routines management application 130 proceeds to step 614 and stores the routine 420 in the data store 126 before ending the method 600. Otherwise, when the routines management application 130 identifies at least one overlapping routine, the routines management application 130 proceeds to step 616 and rejects the routine 420. In such instances, the routines management application 130 can provide a notification to the user 160 that the routine 420 will not be stored. Additionally or alternatively, the routines management application 130 can prompt the user 160 with available actions to take in response to the overlap, such as replacing a characteristic of the routine 420 (e.g., change the specified action, change the condition, etc.), replacing the existing routine, starting again to generate a different routine, and so forth. Upon rejecting the routine 420, the routines management application 130 ends method 600.

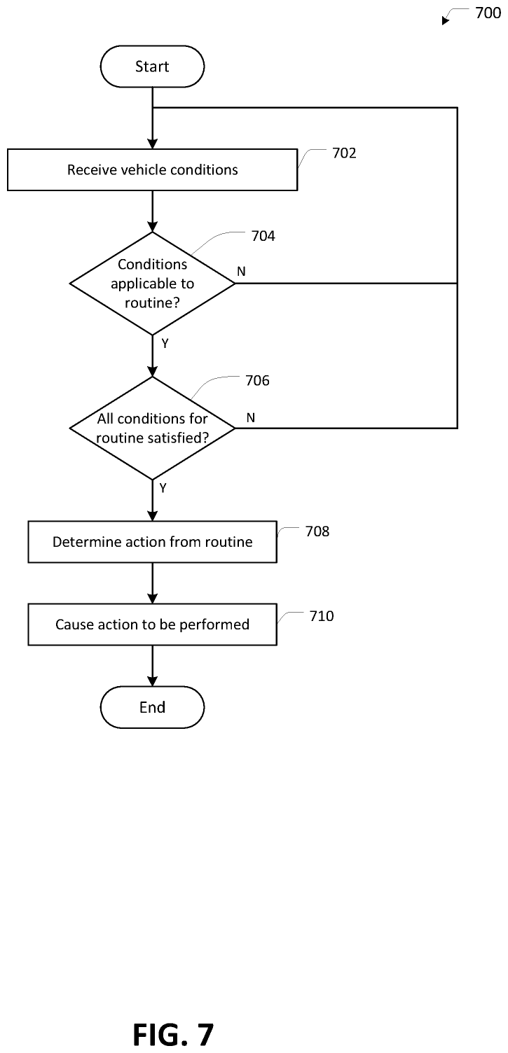

FIG. 7 sets for a flow chart of method steps for responding to detection of one or more satisfied conditions of a rule by performing an action specified by the rule, according to various embodiments. Although the method steps are described with reference to the embodiments of FIGS. 1-5, persons skilled in the art will understand that any system configured to implement the method steps, in any order, falls within the scope of the present disclosure.

As shown in FIG. 7, the method 700 begins at step 702, where the HIE 124 receives a set of vehicle conditions 460. In various embodiments, the rules engine 440 included in the HIE 124 can receive a set of vehicle conditions 460 provided by one or more vehicle components. The vehicle conditions 460 can include various values monitored by the vehicle components (e.g., environmental, physiological, and/or other data acquired by the sensors 172), information associated with applications that a vehicle component is running (e.g., information associated with content items that the entertainment subsystem 228 is playing via a media player), vehicle component states, and so forth. In some embodiments, the rules engine 440 can receive a subset of the vehicle conditions 460 at times when a specific value changes. Additionally or alternatively, the rules engine 440 can periodically receive the vehicle conditions 460.

At step 704, the HIE 124 determines whether the vehicle conditions 460 are applicable to a routine 420. In various embodiments, the rules engine can compare the vehicle conditions 460 to the contents of routines stored in the data store 126. In such instances, the rules engine 440 compares the set of vehicle conditions 460 with the set of conditions for a given routine 420 to determine whether the vehicle conditions 460 are applicable to the routine 420. For example, when the rules engine 440 compares vehicle conditions 460 including a change of audio track that the media player is playing, the rules engine 440 can determine that a given routine 420 includes does not include any conditions associated with the media player. When the rules engine 440 determines that the vehicle conditions 460 are applicable to a routine 420, the HIE 124 proceeds to step 706. Otherwise, when the rules engine 440 determines that the vehicle conditions 460 are not applicable to any routine 420, the HIE 124 returns to step 702 to receive additional vehicle conditions 460.

At step 706, the HIE 124 determines whether the conditions for the routine 420 are satisfied. In various embodiments, the rules engine 440 can compare the information in the vehicle condition 460 with a condition set (e.g., condition set 316) for the routine 420 to determine whether the condition set 316 has been satisfied. When the rules engine 440 determines that the condition set has been satisfied, the HIE 124 proceeds to step 708. Otherwise, when the rules engine 440 determines that the condition set 316 has not been satisfied, the HIE 124 returns to step 702 to wait for additional vehicle conditions 460.

At step 708, the HIE 124 determines the action from the routine 420. In various embodiments, upon determining that the condition set 316 has been satisfied, the rules engine 440 identifies the action set 356 included in the routine 420 that has been satisfied.

At step 710, the HIE 124 causes the action to be performed. In various embodiments, the services interface 450 included in the HIE 124 can generate one or more commands for a specific service that is to perform an action specified by the routine 420. For example, when causing vehicle components to perform the action set 356, the services interface 450 can identify the navigation subsystem 222 as the applicable service and can generate a command to cause the navigation subsystem 222 to set a stored address (‘HOME’) as the target destination of a route. In such instances, the output module 240 can receive the one or more command from the services interface 450 and causes the applicable vehicle component to the perform the command.

In sum, a routines management application receives one or more auditory speech signals from a user to generate a custom routine. In some embodiments, the routines management application can receive a single auditory speech signal that specifies components of a conditional statement that include a context portion and an action portion. Alternatively, the routines management application can provide one or more prompts to cause the user to separate auditory speech signals and a separate auditory speech signal including an action portion. Upon receiving the one or more auditory speech signals, the routines management application parses the auditory speech signals to generate an intent based on components of the conditional statement. The routines management application validates the intent based on one or more pre-existing conditions the vehicle is capable of monitoring and one or more pre-existing actions the vehicle is capable of performing in response to a triggering condition. Upon validating the intent, the routines management application generates a routine based on the intent that includes one or more conditions and one or more corresponding actions. When the user approved the generated routine, the routines management application compares the routine to one or more locally-stored rules. When the routines management application determines that the generated routine does not overlap with at least one locally-stored rule, the routines management application publishes the routine by generating and storing a rule corresponding to the routine.

Additionally or alternatively, a hybrid inference engine monitors a set of values associated with conditions specified in the set of stored rules. Upon detecting a change in one of the set of values, the hybrid inference engine determines whether the conditions for one or more of the stored rules has been satisfied. When the hybrid inference engine determines that the conditions for a given stored rule has been satisfied, the hybrid inference engine identifies the one or more actions specified in the given stored rule and causes one or more components of the vehicle to perform the one or more specified actions.

At least one technical advantage of the disclosed techniques relative to the prior art is that, with the disclosed techniques, users that are not proficient in programming customized vehicle routines can effectively generate and approved custom vehicle routines that respond to various detected conditions, greatly improving the in-vehicle experience for users of the vehicle. In particular, by processing the speech of a user to generate a valid routine to store and monitor, the routines management application relieves users of a vehicle of physical and mental strain to perform a variety of manual tasks associated with the operation of the vehicle. Further, by interpreting the sentiment of a user when dictating a personalized routine, the personalized routines management system provides wider ranges of available conditions to monitor and actions to perform than menu-based user interfaces. These technical advantages provide one or more technological advancements over prior art approaches.

1. In various embodiments, a computer-implemented method comprises receiving a set of auditory speech signals generated by a user, mapping a first speech portion in the set of auditory speech signals to a first condition, where he first condition corresponds to at least a first value associated with an operation of a first component of a vehicle, mapping a second speech portion in the set of auditory speech signals to a first action, where the first action corresponds to at least a first action performed by a second component of the vehicle, generating a routine that includes the first condition and the first action, comparing the routine to a set of stored rules, where each stored rule in the set of stored rules includes at least one condition and at least one action, upon determining that the routine does not overlap with at least one stored rule in the set of stored rules, storing the routine as a first stored rule, subsequent to storing the first stored rule, determining that the first condition has been satisfied, and causing the second component of the vehicle to perform the first action.

2. The computer-implemented method of clause 1, where mapping the first speech portion to the first condition comprises comparing the first speech portion to a set of pre-defined conditions, where each pre-defined condition in the set of pre-defined conditions identifies at least one of a state value for a component of the vehicle, or a measured value generated by a component of the vehicle, or a value determined by a component of the vehicle, determining that the first speech portion corresponds to at least a first pre-defined condition in the set of pre-defined conditions, and setting the first condition to match the first pre-defined condition.

3. The computer-implemented method of clause 1 or 2, further comprising determining that a set of conditions included in a second stored rule have been satisfied, where the set of conditions includes at least a second condition and a third condition, and causing a third component of the vehicle to perform a second action of the second stored rule.

4. The computer-implemented method of any of clauses 1-3, where mapping the second speech portion to the first action comprises comparing the second speech portion to a set of pre-defined actions, where each pre-defined condition in the set of pre-defined actions identifies at least one of a vehicle behavior performed by a component of the vehicle, or an application event executed by a component of the vehicle, or determining that the second speech portion corresponds to at least a first pre-defined action in the set of pre-defined actions, and setting the first action to match the first pre-defined action.

5. The computer-implemented method of any of clauses 1-4, further comprising causing the second component of the vehicle to perform a set of actions included in the routine, where the set of actions includes at least the first action and a second action.

6. The computer-implemented method of any of clauses 1-5, further comprising receiving an indication of a change of one or more values associated with the operation of the first component of the vehicle, where determining that the first condition has been satisfied comprises determining that the change of the one or more values associated with the operation of the first component of the vehicle satisfy the first condition.

7. The computer-implemented method of any of clauses 1-6, where the first component of the vehicle or the second component of the vehicle is an infotainment subsystem, a navigation subsystem, an advanced driver assistance system (ADAS), or a temperature control subsystem.

8. The computer-implemented method of any of clauses 1-7, further comprising determining the first speech portion from a first auditory speech signal included in the set of auditory speech signals, and determining the second speech portion from the first auditory speech signal.

9. The computer-implemented method of any of clauses 1-8, further comprising before receiving a first auditory speech signal in the set of auditory speech signals, providing a first auditory prompt associated with the first condition, where determining the first speech portion from the first auditory speech signal, upon receiving the first auditory speech signal, providing a second auditory prompt associated with the first action, and receiving a second auditory speech signal in the set of auditory speech signals.

10. The computer-implemented method of any of clauses 1-9, further comprising parsing a first auditory speech signal included in the set of auditory speech signals to generate a set of speech portions, generating, based on the set of speech portions, a first intent that specifies (i) a value or state, and (ii) a target set of components, validating the first intent with at least one of a set of pre-defined conditions or a set of pre-defined actions, where the routine is generated in response to validating the first intent.

11. The computer-implemented method of any of clauses 1-10, further comprising determining that the routine overlaps with the at least one stored rule when the routine is a duplicate of the at least one stored rule, or the routine contradicts at least one action included in the at least one stored rule.

12. The computer-implemented method of any of clauses 1-11, further comprising upon determining that the routine overlaps with at least one stored rule in the set of stored rules, providing a prompt to the user to select at least one of (i) replacing the at least one stored rule with the routine, (ii) modifying the routine, or (iii) discarding the routine.

13. In various embodiments, one or more non-transitory computer-readable media of storing instructions that, when executed by one or more processors, cause the one or more processors to perform the steps of receiving a set of auditory speech signals generated by a user, mapping a first speech portion in the set of auditory speech signals to a first condition, where the first condition corresponds to at least a first value associated with an operation of a first component of a vehicle, mapping a second speech portion in the set of auditory speech signals to a first action, where the first action corresponds to at least a first action performed by a second component of the vehicle, generating a routine that includes the first condition and the first action, comparing the routine to a set of stored rules, where each stored rule in the set of stored rules includes at least one condition and at least one action, upon determining that the routine overlaps with at least one stored rule in the set of stored rules, providing a notification to the user that the routine is not to be stored as a first stored rule, or upon determining that the routine does not overlap with the at least one stored rule in the set of stored rules, storing the routine as the first stored rule, subsequent to storing the first stored rule, determining that the first condition has been satisfied, and causing the second component of the vehicle to perform the first action.

14. The one or more non-transitory computer-readable media of clause 13, where the first stored rule comprises a C Language Integrated Production System (CLIPS) rule.

15. The one or more non-transitory computer-readable media of clause 13 or 14, further storing instructions that, when executed by the one or more processors, cause the one or more processors to perform the steps of receiving an indication of a change of one or more values associated with the operation of the first component of the vehicle, where determining that the first condition has been satisfied comprises determining that the change of the one or more values associated with the operation of the first component of the vehicle satisfy the first condition.

16. The one or more non-transitory computer-readable media of any of clauses 13-15, where mapping the second speech portion to the first action comprises comparing the second speech portion to a set of pre-defined actions, where each pre-defined condition in the set of pre-defined actions identifies at least one of a vehicle behavior performed by a component of the vehicle, or an application event executed by a component of the vehicle, or determining that the second speech portion corresponds to at least a first pre-defined action in the set of pre-defined actions, and setting the first action to match the first pre-defined action.

17. The one or more non-transitory computer-readable media of clauses 13-16, where determining that the routine overlaps with the at least one stored rule comprises determining that (i) the routine is a duplicate of the at least one stored rule, or (ii) the routine contradicts at least one action included in the at least one stored rule, and the notification includes a prompt to the user to select at least one of (i) replacing the at least one stored rule with the routine, (ii) modifying the routine, or (iii) discarding the routine.

18. In various embodiments, a system comprises a memory storing a routines management application, and a processor coupled to the memory that executes the routines management application by performing the steps of receiving a set of auditory speech signals generated by a user, mapping a first speech portion in the set of auditory speech signals to a first condition, where the first condition corresponds to at least a first value associated with an operation of a first component of a vehicle, mapping a second speech portion in the set of auditory speech signals to a first action, where the first action corresponds to at least a first action performed by a second component of the vehicle, generating a routine that includes the first condition and the first action, comparing the routine to a set of stored rules, where each stored rule in the set of stored rules includes at least one condition and at least one action, upon determining that the routine does not overlap with at least one stored rule in the set of stored rules, storing the routine as a first stored rule, upon storing the first stored rule, determining that the first condition has been satisfied, and causing the second component of the vehicle to perform the first action.

19. The system of clause 18, where the memory further stores a hybrid inference engine (HIE) service, and the processor further executes the HIE service by performing the steps of receiving an indication of a change of one or more values associated with the operation of the first component of the vehicle, where determining that the first condition has been satisfied comprises determining that the change of the one or more values associated with the operation of the first component of the vehicle satisfy the first condition.

20. The system of clause 18 or 19, where the first component of the vehicle or the second component of the vehicle include at least one of an infotainment subsystem, a navigation subsystem, an advanced driver assistance system (ADAS), or a temperature control subsystem.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method, or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method comprising:
receiving a set of auditory speech signals generated by a user;
mapping a first speech portion in the set of auditory speech signals to a first condition, wherein the first condition corresponds to at least a first value associated with an operation of a first component of a vehicle;
mapping a second speech portion in the set of auditory speech signals to a first action, wherein the first action corresponds to at least a first action performed by a second component of the vehicle;
generating a routine that includes the first condition and the first action;
comparing the routine to a set of stored rules, wherein each stored rule in the set of stored rules includes at least one condition and at least one action;
upon determining that the routine does not overlap with at least one stored rule in the set of stored rules, storing the routine as a first stored rule;
subsequent to storing the first stored rule, determining that the first condition has been satisfied; and
causing the second component of the vehicle to perform the first action.

2. The computer-implemented method of claim 1, wherein mapping the first speech portion to the first condition comprises:
comparing the first speech portion to a set of pre-defined conditions, wherein each pre-defined condition in the set of pre-defined conditions identifies at least one of:
a state value for a component of the vehicle, or
a measured value generated by a component of the vehicle, or
a value determined by a component of the vehicle;
determining that the first speech portion corresponds to at least a first pre-defined condition in the set of pre-defined conditions; and
setting the first condition to match the first pre-defined condition.

3. The computer-implemented method of claim 1, further comprising:
determining that a set of conditions included in a second stored rule have been satisfied, wherein the set of conditions includes at least a second condition and a third condition; and
causing a third component of the vehicle to perform a second action of the second stored rule.

4. The computer-implemented method of claim 1, wherein mapping the second speech portion to the first action comprises:
comparing the second speech portion to a set of pre-defined actions, wherein each pre-defined condition in the set of pre-defined actions identifies at least one of:
a vehicle behavior performed by a component of the vehicle, or
an application event executed by a component of the vehicle, or
determining that the second speech portion corresponds to at least a first pre-defined action in the set of pre-defined actions, and
setting the first action to match the first pre-defined action.

5. The computer-implemented method of claim 1, further comprising:
causing the second component of the vehicle to perform a set of actions included in the routine,
wherein the set of actions includes at least the first action and a second action.

6. The computer-implemented method of claim 1, further comprising:
receiving an indication of a change of one or more values associated with the operation of the first component of the vehicle,
wherein determining that the first condition has been satisfied comprises determining that the change of the one or more values associated with the operation of the first component of the vehicle satisfy the first condition.

7. The computer-implemented method of claim 1, wherein the first component of the vehicle or the second component of the vehicle is an infotainment subsystem, a navigation subsystem, an advanced driver assistance system (ADAS), or a temperature control subsystem.

8. The computer-implemented method of claim 1, further comprising:
determining the first speech portion from a first auditory speech signal included in the set of auditory speech signals; and
determining the second speech portion from the first auditory speech signal.

9. The computer-implemented method of claim 1, further comprising:
before receiving a first auditory speech signal in the set of auditory speech signals, providing a first auditory prompt associated with the first condition, wherein
determining the first speech portion from the first auditory speech signal;
upon receiving the first auditory speech signal, providing a second auditory prompt associated with the first action; and
receiving a second auditory speech signal in the set of auditory speech signals.

10. The computer-implemented method of claim 1, further comprising:
parsing a first auditory speech signal included in the set of auditory speech signals to generate a set of speech portions;
generating, based on the set of speech portions, a first intent that specifies (i) a value or state, and (ii) a target set of components;
validating the first intent with at least one of a set of pre-defined conditions or a set of pre-defined actions, wherein the routine is generated in response to validating the first intent.

11. The computer-implemented method of claim 1, further comprising determining that the routine overlaps with the at least one stored rule when:
the routine is a duplicate of the at least one stored rule; or
the routine contradicts at least one action included in the at least one stored rule.

12. The computer-implemented method of claim 11, further comprising upon determining that the routine overlaps with at least one stored rule in the set of stored rules, providing a prompt to the user to select at least one of (i) replacing the at least one stored rule with the routine, (ii) modifying the routine, or (iii) discarding the routine.

13. One or more non-transitory computer-readable media of storing instructions that, when executed by one or more processors, cause the one or more processors to perform the steps of:
receiving a set of auditory speech signals generated by a user;
mapping a first speech portion in the set of auditory speech signals to a first condition, wherein the first condition corresponds to at least a first value associated with an operation of a first component of a vehicle;
mapping a second speech portion in the set of auditory speech signals to a first action, wherein the first action corresponds to at least a first action performed by a second component of the vehicle;
generating a routine that includes the first condition and the first action;
comparing the routine to a set of stored rules, wherein each stored rule in the set of stored rules includes at least one condition and at least one action;
upon determining that the routine overlaps with at least one stored rule in the set of stored rules, providing a notification to the user that the routine is not to be stored as a first stored rule; or
upon determining that the routine does not overlap with the at least one stored rule in the set of stored rules:
storing the routine as the first stored rule;
subsequent to storing the first stored rule, determining that the first condition has been satisfied; and
causing the second component of the vehicle to perform the first action.

14. The one or more non-transitory computer-readable media of claim 13, wherein the first stored rule comprises a C Language Integrated Production System (CLIPS) rule.

15. The one or more non-transitory computer-readable media of claim 13, further storing instructions that, when executed by the one or more processors, cause the one or more processors to perform the steps of:
receiving an indication of a change of one or more values associated with the operation of the first component of the vehicle,
wherein determining that the first condition has been satisfied comprises determining that the change of the one or more values associated with the operation of the first component of the vehicle satisfy the first condition.

16. The one or more non-transitory computer-readable media of claim 13, wherein mapping the second speech portion to the first action comprises:
comparing the second speech portion to a set of pre-defined actions, wherein each pre-defined condition in the set of pre-defined actions identifies at least one of:
a vehicle behavior performed by a component of the vehicle, or
an application event executed by a component of the vehicle, or
determining that the second speech portion corresponds to at least a first pre-defined action in the set of pre-defined actions, and
setting the first action to match the first pre-defined action.

17. The one or more non-transitory computer-readable media of claim 13, wherein:
determining that the routine overlaps with the at least one stored rule comprises determining that (i) the routine is a duplicate of the at least one stored rule, or (ii) the routine contradicts at least one action included in the at least one stored rule; and
the notification includes a prompt to the user to select at least one of (i) replacing the at least one stored rule with the routine, (ii) modifying the routine, or (iii) discarding the routine.

18. A system comprising:
a memory storing a routines management application; and
a processor coupled to the memory that executes the routines management application by performing the steps of:
receiving a set of auditory speech signals generated by a user;
mapping a first speech portion in the set of auditory speech signals to a first condition, wherein the first condition corresponds to at least a first value associated with an operation of a first component of a vehicle;
mapping a second speech portion in the set of auditory speech signals to a first action, wherein the first action corresponds to at least a first action performed by a second component of the vehicle;
generating a routine that includes the first condition and the first action;
comparing the routine to a set of stored rules, wherein each stored rule in the set of stored rules includes at least one condition and at least one action;
upon determining that the routine does not overlap with at least one stored rule in the set of stored rules, storing the routine as a first stored rule;
upon storing the first stored rule, determining that the first condition has been satisfied; and
causing the second component of the vehicle to perform the first action.

19. The system of claim 18, wherein:
the memory further stores a hybrid inference engine (HIE) service; and
the processor further executes the HIE service by performing the steps of:
receiving an indication of a change of one or more values associated with the operation of the first component of the vehicle,
wherein determining that the first condition has been satisfied comprises determining that the change of the one or more values associated with the operation of the first component of the vehicle satisfy the first condition.

20. The system of claim 18, wherein the first component of the vehicle or the second component of the vehicle include at least one of an infotainment subsystem, a navigation subsystem, an advanced driver assistance system (ADAS), or a temperature control subsystem.
